(19) United States
(12) Patent Application Publication
(10) Pub. No.: US 2022/0222493 A1
(43) Pub. Date: Jul. 14, 2022

(54) DEVICE AND METHOD TO IMPROVE REINFORCEMENT LEARNING WITH SYNTHETIC ENVIRONMENT

(71) Applicant: Robert Bosch GmbH, Stutigart (DE)

(72) Inventors: Thomas Nierhoff, Augsburg (DE); Fabio Ferreira, Weingarten (DE); Frank Hutter, Freiburg (DE)

(21) Appl. No.: 17/644,179

(22) Filed: Dec. 14, 2021

(30) Foreign Application Priority Data
Jan. 8, 2021 (EP) 21 15 0717.3

(51) Int. Cl. G06K 9/62; G06N 3/04; G06N 3/12

(52) U.S. Cl. CPC G06K 9/6262; G06K 9/6257; G06N 3/126; G06N 3/0472; G06K 9/6255

(57) ABSTRACT

A computer-implemented method for learning a strategy and/or method for learning a synthetic environment. The strategy is configured to control an agent, and the method includes: providing synthetic environment parameters and a real environment and a population of strategies. Subsequently, repeating the following steps for a predetermined number of repetitions as a first loop: carrying out for each strategy of the population of strategies subsequent steps as a second loop: disturb the synthetic environment parameters with random noise; train for a first given number of step the strategy on the disturbed synthetic environment; evaluate the trained strategy on the real environment by determining rewards of the trained strategies; updating the synthetic environment parameters depending on the noise and the rewards. Finally, outputting the evaluated strategy with the highest reward on the real environment or with the best trained strategy on the disturbed synthetic environment.

### CROSS REFERENCE

The present applicant claims the benefit under 35 U.S.C. § 119 of European Patent Application No. EP 21150717.3 filed on Jan. 8, 2021, which is expressly incorporated herein by reference in its entirety.

### FIELD

The present invention relates to a method for improved learning of a strategy for agents by learning a synthetic environment, and a method for operating an actuator by the strategy, a computer program and a machine-readable storage medium, a classifier, a control system, and a training system.

### BACKGROUND INFORMATION

The paper of the authors Such, Felipe Petroski, et al. “Generative teaching networks: Accelerating neural architecture search by learning to generate synthetic training data.” International Conference on Machine Learning. PMLR, 2020 (available online: https://arxiv.org/abs/1912.07768), describes a general learning framework called the “Generative Teaching Networks” (GTNs) which consist of two neural networks, which act together in a bi-level optimization to produce a small, synthetic dataset.

### SUMMARY

In contrast to the above mentioned paper of the authors Such et al, the present invention is different in central aspects. Particularly, the present invention does not use noise vectors as input for generating synthetic datasets. Furthermore, the GTN setting is applied to reinforcement learning (RL) instead of supervised learning. Also, the present invention uses Evolutionary Search (ES) to avoid the need for explicitly computing second-order meta-gradients. ES is beneficial since explicitly computing second-order meta-gradients are not required, which can be expensive and unstable, particularly in the RL setting where the length of the inner loop can be variant and high. ES can further easily be parallelized and enables the method according to the present invention to be agent-agnostic.

The present invention enables to learn agent-agnostic synthetic environments (SEs) for Reinforcement Learning. SEs act as a proxy for target environments and allow agents to be trained more efficiently than when directly trained on the target environment. By using Natural Evolution Strategies and a population of SE parameter vectors, the present invention is capable of learning SEs that allow to train agents more robustly and with up to 50-75% fewer steps on the real environment.

Hence, the present invention improves RL by learning a proxy data generating process that allows one to train learners more effectively and efficiently on a task, that is, to achieve similar or higher performance more quickly compared to when trained directly on the original data generating process.

Another advantage is that due to the separated optimization of the strategy of an agent and the synthetic environment, the invention is compatible with all different approaches for training reinforcement learning agents, e.g. policy gradient or Deep Q-Learning.

In a first aspect, the present invention relates to a computer-implemented method for learning a strategy which is configured to control an agent. This means that the strategy determines an action for the agent depending on at least a provided state of the environment of the agent.

In accordance with an example embodiment of the present invention, the method comprises the following steps:

Initially providing synthetic environment parameters and a real environment and a population of initialized strategies. The synthetic environment is characterized by the fact that it will be constructed as well as learned while learning the strategy and it is indirectly learned depending on the real environment. This implies that the synthetic environment is a virtual reproduction of the real environment.

The agent can directly interact with the real and synthetic environment, for instance by carrying out an action and immediately receiving the state of the environment after said action. The difference is that the received state by the synthetic environment is determined depending on the synthetic environment parameters, wherein the received state by the real environment is either sensed by a sensor or determined by exhaustive simulations of the real environment.

Thereupon follows a repeating of subsequent steps for a predetermined number of repetitions as a first loop. The first loop comprises at least the steps of carrying out a second loop over all strategies of the population and afterwards updating the parameters of the synthetic environment to better align it to the real environment, more precisely to provide a better proxy environment to allow agents learned on the proxy to find a more powerful strategy for the real environment.

In the first step of the first loop, the second loop is carried out over each strategy of the population of strategies. The second loop comprises the following steps for each selected strategy of the population of strategies:

At first, the parameters of the synthetic environment is disturbed with random noise. More precisely, noise is randomly drawn from a isotropic multivariate Gaussian with mean equal to zero and covariance equal to a given variance.

Thereupon, for a given number of steps/episodes, the selected strategy of the population of strategies is trained on the disturbed synthetic environment. The training is carried out as reinforcement learning, e.g. optimize the agent to optimize (e.g. maximize or minimize) a reward or regret by carrying out actions to reach a goal or goal state within an environment.

Thereupon, the trained strategies are evaluated on the real environment by determining rewards of the trained strategies.

If the second loop has been carried out for each strategy of the population, then the further step within the first loop is carried out. This step comprises updating the synthetic environment parameters depending on the rewards determined in the just finished second loop. Preferably, said parameters are also updated depending on the noise utilized in the second loop.

If the first loop has been terminated, the evaluated strategy with the highest reward on the real environment or with the best trained strategy on the disturbed synthetic environment is outputted.

Due to the evolutionary strategy and to train alternately both the synthetic environment as well as the strategies, a more robust and efficient training is obtained.

It is provided that for the training in the second loop, each strategy is randomly initialized before it is trained on the disturbed synthetic environment. This has the advantage that learned synthetic environments do not overfit (i.e., do not memorize and exploit specific agent behaviors) to the agents and allow for generalization across different types of agents/strategies. Moreover, this allows designers/users to exchange agents and their initializations and do not limit users to specific settings of the agents.

It is further provided that training of the strategies are terminated if a change of a moving average of the cumulative rewards over the last several previous episodes are smaller than a given threshold. This has the advantage that a reliable heuristic is provided as an early-stop criterion to further improve the efficiency of the method of the first aspect.

It is further provided that the synthetic environment is represented by a neural network, wherein the synthetic environment parameters comprises weights of said neural network.

In a second aspect of the present invention, a computer program and an apparatus configured to carry out the method of the first aspect are provided.

Example embodiments of the present invention will be discussed with reference to the figures in more detail.

### BRIEF DESCRIPTION OF THE DRAWINGS

FIG. 1 show Natural Evolution Strategies for learning synthetic environments.

FIG. 2 shows a control system having a classifier controlling an actuator in its environment, in accordance with an example embodiment of the present invention.

FIG. 2 shows a control system controlling an at least partially autonomous robot, in accordance with an example embodiment of the present invention.

FIG. 3 shows ae control system controlling an access control system, in accordance with an example embodiment of the present invention.

FIG. 4 shows a control system controlling a surveillance system, in accordance with an example embodiment of the present invention.

FIG. 5 shows a control system controlling an imaging system, in accordance with an example embodiment of the present invention.

FIG. 6 shows a control system controlling a manufacturing machine, in accordance with an example embodiment of the present invention.

### DETAILED DESCRIPTION OF EXAMPLE EMBODIMENTS

We consider a Markov Decision Process represented by a 4-tuple (S,A,P,R) with S as the set of states, A as the set of actions, P as the transition probabilities between states if a specific action is executed in that state and R as the immediate rewards. The MDPs we will consider are either human-designed environments ϵᵣₑₐₗ or learned synthetic environments ϵ_{syn} referred to as SE, which is preferably represented by a neural network with the parameters ψ. Interfacing with the environments is in both cases almost identical: given an input aϵA, the environment outputs a next state s′ϵS and a reward. Preferably in the case of ϵ_{syn}, we additionally input the current state sϵS because then it can be modeled to be stateless.

The central objective of an RL agent when interacting on an MDP ϵᵣₑₐₗ is to find an optimal policy πₑ parameterized by θ that maximizes the expected reward F(θ; ϵ_{syn}). In RL, there exist many different methods to optimize this objective, for example policy gradient (Sutton, R. S.; McAllester, D.; Singh, S.; and Mansour, Y., 2000, “Policy Gradient Methods for Reinforcement Learning with Function Approximation,” in NeurIPS 2000.) or Deep Q-Learning (Hosu, I.; and Rebedea, T., 2016, “Playing Atari Games with Deep Reinforcement Learning and Human Checkpoint Replay,” CoRR abs/1607.05077). We now consider the following bi-level optimization problem: find the parameters ψ*, such that the policy πₑ found by an agent parameterized by θ that trains on ϵ_{syn} will achieve the highest reward on a target environment ϵᵣₑₐₗ. Formally that is:

$$ψ *= arg {max}_{ψ} F ( {θ}^{*} ( ψ ) ; {ϵ}_{real} )$$

$$s . t . {θ}^{*} ( ψ ) = arg {max}_{θ} F ( θ ; {ϵ}_{syn} )$$

We can use standard RL algorithms (e.g. policy gradient or Q-learning) for optimizing the strategies of the agents on the SE in the inner loop. Although gradient-based optimization methods can be applied in the outer loop, we chose Natural Evolution Strategies (NES) over such methods to allow the optimization to be independent of the choice of the agent in the inner loop and to avoid computing potentially expensive and unstable meta-gradients. Additional advantages of ES are that it is better suited for long episodes (which often occur in RL), sparse or delayed rewards, and parallelization.

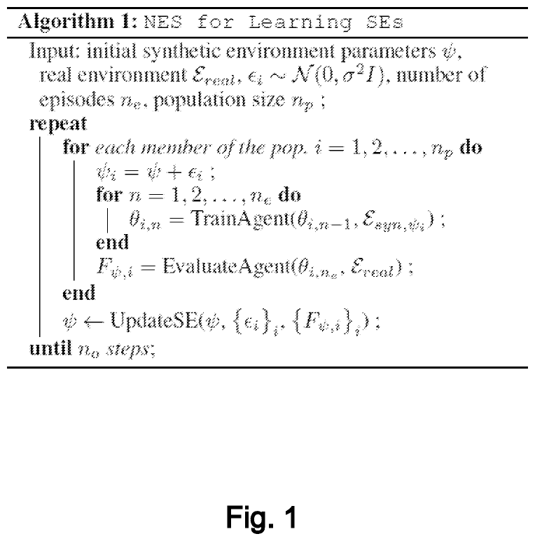

Based on the formulated problem statement, let us now explain the method in accordance with the present invention. The overall NES scheme is adopted from Salimans et al. (see Salimans, T.; Ho, J.; Chen, X.; and Sutskever, I., 2017, “Evolution Strategies as a Scalable Alternative to Reinforcement Learning,” arXiv:1703.03864) and depicted in Algorithm 1 in FIG. 1. We instantiate the search distribution as an isotropic multivariate Gaussian with mean 0 and a covariance σ²I yielding the score function estimator

$$\frac{1}{σ} {E}_{ϵ ∼ N ( 0 , I )} \{ F ( ψ + σϵ ) ϵ \} .$$

The main difference to Salimans et al. is that, while they maintain a population over perturbed agent parameter vectors, the population according to the present invention consists of perturbed SE parameter vectors. In contrast to their approach, the NES approach in accordance with the present invention also involves two optimizations, namely that of the agent and the SE parameters instead of only the agent parameters.

The algorithm in accordance with the present invention first stochastically perturbs each population member according to the search distribution resulting in ψᵢ. Then, a new randomly initialized agent is trained in TrainAgent on the SE parameterized by ψᵢ for nₑ episodes. The trained strategy of the agent with optimized parameters is then evaluated on the real environment in EvaluateAgent, yielding the average cumulative reward across, e.g., 10 test episodes which we use as a score F_{ψ,i} in the above score function estimator. Finally, we update ψ in UpdateSE with a stochastic gradient estimate based on all member scores via a weighted sum:

$$ψ < - ψ + α \frac{1}{{n}_{p} σ} {Σ}_{i}^{{n}_{p}} {F}_{i} {ϵ}_{i} .$$

Preferably we repeat this process nₒ times but perform manual early-stopping when a resulting SE is capable of training agents that consistently solve the target task. Preferably, a parallel version of the algorithm can be used by utilizing one worker for each member of the population at the same time.

Determining the number of required training episodes nₑ on an SE is challenging as the rewards of the SE may not provide information about the current agent's performance on the real environment. Thus, we optionally use a heuristic to early-stop training once the agent's training performance on the synthetic environment converged. Let us refer to the cumulative reward of the k-th training episode as Cₖ. The two values C_{d} and C_{2d} maintain a non-overlapping moving average of the cumulative rewards over the last d and 2d respective episodes k. Now, if |C_{d}−C_{2d}|/|C_{2d}|≤C_{diff} the training is stopped. Exemplarly, d=10 and C_{diff}=0.01. Training of agents on real environments is stopped when the average cumulative reward across the last d test episodes exceeds the solved reward threshold.

Independent of which of the environments (ϵᵣₑₐₗ or ϵ_{syn}) we train an agent on, the process to assess the actual agent performance is equivalent: we do this by running the agent on 10 test episodes from ϵᵣₑₐₗ for a fixed number of task specific steps (i.e. 200 on CartPole-v0 and 500 on Acrobotv1) and use the cumulative rewards for each episode as a performance proxy.

Due to known sensitivity to hyperparameters (HPs), one can additionally apply a hyperparameter optimization. In addition to the inner and outer loop of the algorithm in accordance with the present invention, one can use another outer loop to optimize some of the agent and NES HPs with BOHB (see Falkner, S.; Klein, A.; and Hutter, F. 2018, “BOHB: Robust and Efficient Hyperparameter Optimization at Scale,” in Proc. of ICML '18, 1437-1446.) to identify stable HPs.

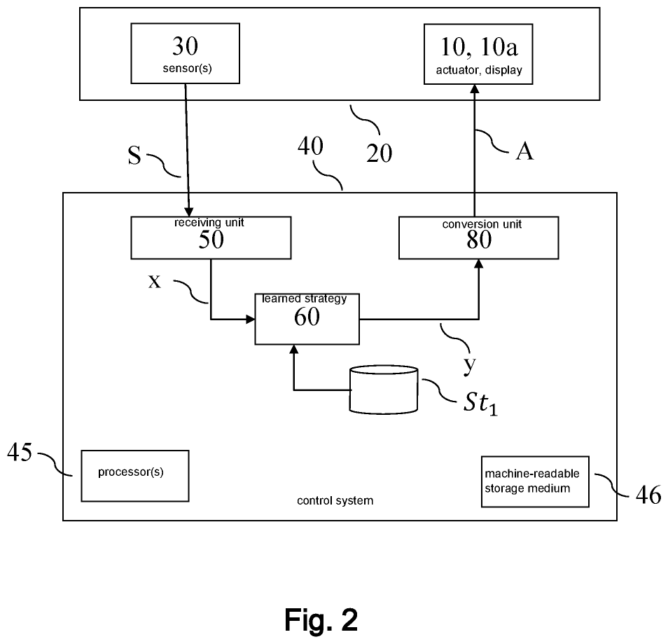

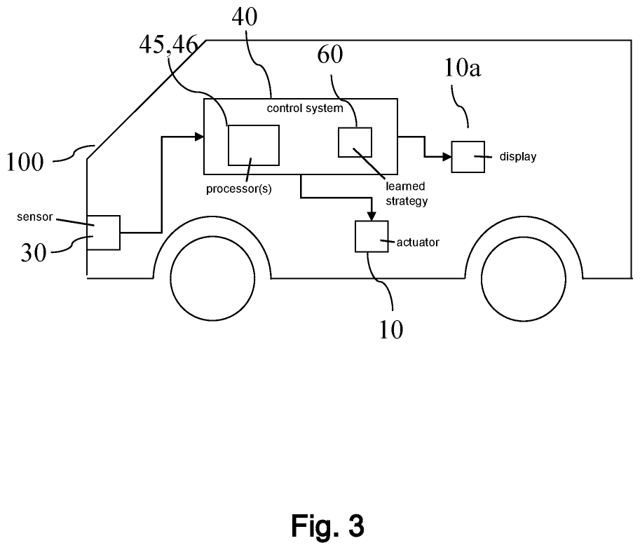

Shown in FIG. 2 is one embodiment of an actuator 10 in its environment 20. Actuator 10 interacts with a control system 40. Actuator 10 and its environment 20 will be jointly called actuator system. At preferably evenly spaced distances, a sensor 30 senses a condition of the actuator system. The sensor 30 may comprise several sensors. Preferably, sensor 30 is an optical sensor that takes images of the environment 20. An output signal S of sensor 30 (or, in case the sensor 30 comprises a plurality of sensors, an output signal S for each of the sensors) which encodes the sensed condition is transmitted to the control system 40.

Thereby, control system 40 receives a stream of sensor signals S. It then computes a series of actuator control commands A depending on the stream of sensor signals S, which are then transmitted to actuator 10.

Control system 40 receives the stream of sensor signals S of sensor 30 in an optional receiving unit 50. Receiving unit 50 transforms the sensor signals S into input signals x. Alternatively, in case of no receiving unit 50, each sensor signal S may directly be taken as an input signal x. Input signal x may, for example, be given as an excerpt from sensor signal S. Alternatively, sensor signal S may be processed to yield input signal x. Input signal x comprises image data corresponding to an image recorded by sensor 30. In other words, input signal x is provided in accordance with sensor signal S.

Input signal x is then passed on to a learned strategy 60, obtained as described above, which may, for example, be given by an artificial neural network.

Strategy 60 is parametrized by parameters, which are stored in and provided by parameter storage St₁.

Strategy 60 determines output signals y from input signals x. The output signal y characterizes an action. Output signals y are transmitted to an optional conversion unit 80, which converts the output signals y into the control commands A. Actuator control commands A are then transmitted to actuator 10 for controlling actuator 10 accordingly. Alternatively, output signals y may directly be taken as control commands A.

Actuator 10 receives actuator control commands A, is controlled accordingly and carries out an action corresponding to actuator control commands A. Actuator 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

In still further embodiments, it may be envisioned that control system 40 controls a display 10a instead of an actuator 10.

Furthermore, control system 40 may comprise a processor 45 (or a plurality of processors) and at least one machine-readable storage medium 46 on which instructions are stored which, if carried out, cause control system 40 to carry out a method according to one aspect of the invention.

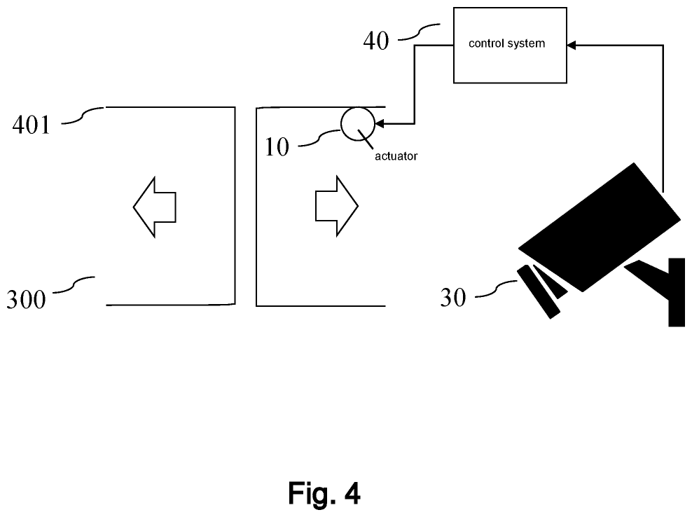

FIG. 3 shows an embodiment in which control system 40 is used to control an at least partially autonomous robot, e.g. an at least partially autonomous vehicle 100.

Sensor 30 may comprise one or more video sensors and/or one or more radar sensors and/or one or more ultrasonic sensors and/or one or more LiDAR sensors and or one or more position sensors (like e.g. GPS). Some or all of these sensors are preferably but not necessarily integrated in vehicle 100.

Alternatively or additionally sensor 30 may comprise an information system for determining a state of the actuator system. One example for such an information system is a weather information system which determines a present or future state of the weather in environment 20.

For example, using input signal x, the strategy 60 may for example control the robot such that a goal is reached with a minimal number of steps.

Actuator 10, which is preferably integrated in vehicle 100, may be given by a brake, a propulsion system, an engine, a drivetrain, or a steering of vehicle 100. Actuator control commands A may be determined such that actuator (or actuators) 10 is/are controlled such that vehicle 100 avoids collisions with objects.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, actuator command control A may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses sensor 30, preferably an optical sensor, to determine a state of plants in the environment 20. Actuator 10 may be a nozzle for spraying chemicals. Depending on an identified species and/or an identified state of the plants, an actuator control command A may be determined to cause actuator 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

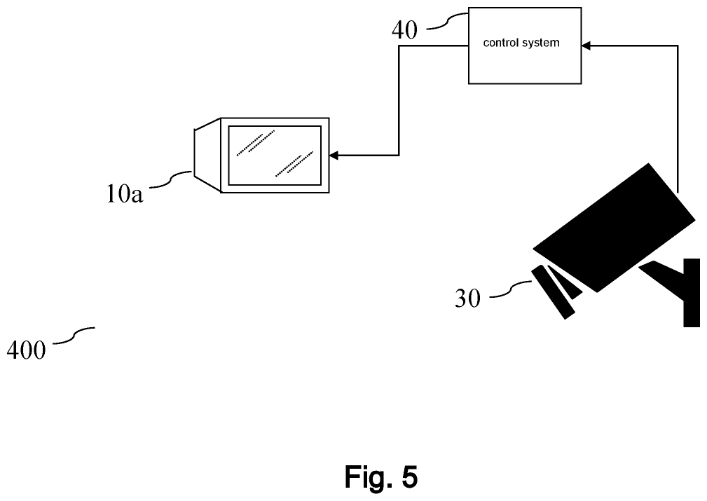

Shown in FIG. 4 is an embodiment in which control system controls an access control system 300. Access control system may be designed to physically control access. It may, for example, comprise a door 401. Sensor 30 is configured to detect a scene that is relevant for deciding whether access is to be granted or not. It may for example be an optical sensor for providing image or video data, for detecting a person's face. Strategy 60 may be configured to interpret this image or video data. Actuator control signal A may then be determined depending on the interpretation of strategy 60, e.g. in accordance with the determined identity. Actuator 10 may be a lock which grants access or not depending on actuator control signal A. A non-physical, logical access control is also possible.

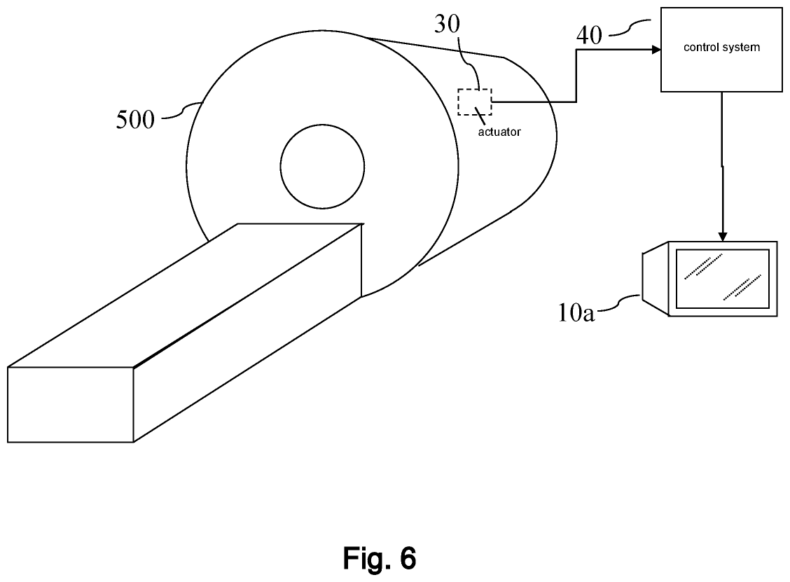

Shown in FIG. 5 is an embodiment in which control system 40 controls a surveillance system 400. This embodiment is largely identical to the embodiment shown in FIG. 5. Therefore, only the differing aspects will be described in detail. Sensor 30 is configured to detect a scene that is under surveillance. Control system does not necessarily control an actuator 10, but a display 10a. For example, strategy 60 may determine e.g. whether the scene detected by optical sensor 30 is suspicious. Actuator control signal A which is transmitted to display 10a may then e.g. be configured to cause display 10a to adjust the displayed content dependent on the determined classification, e.g. to highlight an object that is deemed suspicious by strategy 60.

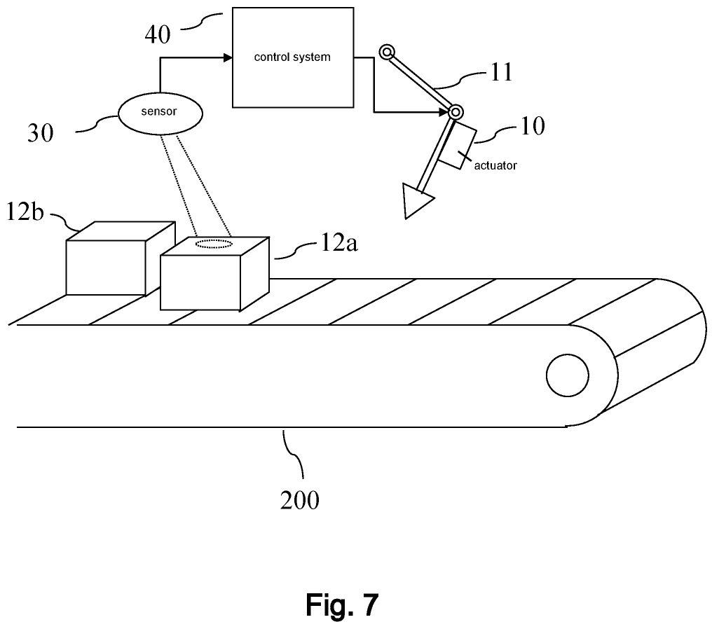

Shown in FIG. 6 is an embodiment of a control system 40 for controlling an imaging system 500, for example an MRI apparatus, x-ray imaging apparatus or ultrasonic imaging apparatus. Sensor 30 may, for example, be an imaging sensor. Strategy 60 may then determine a region for taking the image. Actuator control signal A may then be chosen in accordance with this region, thereby controlling display 10a.

Shown in FIG. 7 is an embodiment in which control system 40 is used to control a manufacturing machine 11, e.g. a punch cutter, a cutter or a gun drill) of a manufacturing system 200, e.g. as part of a production line. The control system 40 controls an actuator 10 which in turn control the manufacturing machine 11.

Sensor 30 may be given by an optical sensor which captures properties of e.g. a manufactured product 12. Strategy 60 may determine depending on a state of the manufactured product 12, e.g. from these captured properties, a corresponding action to manufacture the final product. Actuator 10 which controls manufacturing machine 11 may then be controlled depending on the determined state of the manufactured product 12 for a subsequent manufacturing step of manufactured product 12.

What is claimed is:

1. A computer-implemented method for learning a strategy, which is configured to control an agent, the method comprising the following steps:
providing synthetic environment parameters, a real environment, and a population of initialized strategies;
repeating subsequent steps for a predetermined number of repetitions as a first loop:
(1) carrying out for each strategy of the population of strategies subsequent steps as a second loop:
(a) disturbing the synthetic environment parameters with random noise;
(b) training the strategy on the synthetic environment constructed depending on the disturbed synthetic environment parameters; and
(c) determining rewards achieved by the trained strategy, which is applied on the real environment;
(2) updating the synthetic environment parameters depending on the rewards of the trained strategies of the second loop; and
outputting the strategy of the trained strategies, which achieved a highest reward on the real environment or which achieved a highest reward during training on the synthetic environment.

2. The method according to claim 1, wherein the updating of the synthetic environment parameters is carried out by stochastic gradient estimate based on a weighted sum of the determined rewards of the trained strategies in the second loop.

3. The method according to claim 1, wherein the training of the strategies of the population of strategies are carried out in parallel.

4. The method according to claim 1, wherein each strategy is randomly initialized before training the strategy on the synthetic environment.

5. The method according to claim 1, wherein the step of training the strategy is terminated if a change of a moving average of cumulative rewards over a given number previous episodes of the training is smaller than a given threshold.

6. The method according to claim 1, wherein a Hyperparameter Optimization is carried out to optimize hyperparameters of a training method for the training of the strategies and/or of an optimization method for updating the synthetic environment parameters.

7. The method according to claim 1, wherein the synthetic environment is represented by a neural network, wherein the synthetic environment parameters are weights of the neural network.

8. The method according to claim 1, wherein an actuator of the agent is controlled depending on determined actions by the outputted strategy.

9. The method according to claim 8, wherein the agent is an at least partially autonomous robot and/or a manufacturing machine and/or an access control system.

10. A computer-implemented method for learning a synthetic environment, providing synthetic environment parameters and a real environment and a population of initialized strategies, the method comprising the following steps:
repeating subsequent steps for a predetermined number of repetitions as a first loop:
(1) carrying out for each strategy of the population of strategies subsequent steps as a second loop:
(a) disturbing the synthetic environment parameters with random noise;
(b) training the strategy on the synthetic environment constructed depending on the disturbed synthetic environment parameters;
(c) determining rewards achieved by the trained strategy, which is applied on the real environment;
(2) updating the synthetic environment parameters depending on the rewards of the trained strategies of the second loop; and
outputting the updated synthetic environment parameters.

11. A non-transitory machine-readable storage medium on which is stored a computer program for learning a strategy, which is configured to control an agent, the computer program, when executed by a computer, causing the computer to perform the following steps:
providing synthetic environment parameters, a real environment, and a population of initialized strategies;
repeating subsequent steps for a predetermined number of repetitions as a first loop:
(1) carrying out for each strategy of the population of strategies subsequent steps as a second loop:
(a) disturbing the synthetic environment parameters with random noise;
(b) training the strategy on the synthetic environment constructed depending on the disturbed synthetic environment parameters; and
(c) determining rewards achieved by the trained strategy, which is applied on the real environment;
(2) updating the synthetic environment parameters depending on the rewards of the trained strategies of the second loop; and
outputting the strategy of the trained strategies, which achieved a highest reward on the real environment or which achieved a highest reward during training on the synthetic environment.

12. An apparatus configured for learning a strategy, which is configured to control an agent, the apparatus being configured to:
provide synthetic environment parameters, a real environment, and a population of initialized strategies;
repeat the following for a predetermined number of repetitions as a first loop:
(1) carry out for each strategy of the population of strategies the following as a second loop:
(a) disturb the synthetic environment parameters with random noise;
(b) train the strategy on the synthetic environment constructed depending on the disturbed synthetic environment parameters; and
(c) determine rewards achieved by the trained strategy, which is applied on the real environment;
(2) update the synthetic environment parameters depending on the rewards of the trained strategies of the second loop; and
output the strategy of the trained strategies, which achieved a highest reward on the real environment or which achieved a highest reward during training on the synthetic environment.
